(19) United States
(12) Patent Application Publication
(10) Pub. No.: US 2024/0370248 A1
(43) Pub. Date: Nov. 7, 2024

(54) HASH TREE BASED OVER-THE-AIR (OTA) SOFTWARE PROVISIONING AND VERIFICATION

(71) Applicant: The Regents of the University of Michigan, Ann Arbor, MI (US)

(72) Inventors: Di MA, Dearborn, MI (US); Abir Younes BAZZI, Dearborn, MI (US); Adnan K. SHAOUT, Canton, MI (US)

(21) Appl. No.: 18/652,256

(22) Filed: May 1, 2024

Related U.S. Application Data
(60) Provisional application No. 63/463,275, filed on May 1, 2023.

(51) Int. Cl. G06F 8/65; G06F 8/61

(52) U.S. Cl. CPC G06F 8/65; G06F 8/63

(57) ABSTRACT

A system, apparatus, and method for deploying software to a target device. The system is configured to perform the method, and the method includes: receiving a software image and a root signature generated based on the software image; determining a software image hash based on the software image; determining a client-side root of a hash tree based on the software image hash; decrypting the root signature to obtain a server-side root; determining whether the server-side root matches the client-side root; and configuring software on a target device using the software image when the server-side root matches the client-side root.

### TECHNICAL FIELD

This disclosure relates to methods and systems for distributing software securely and, more particularly, securing over-the-air (OTA) updates for connected devices, such as vehicles, through use of cryptographic techniques.

### BACKGROUND

Software over-the-air (SOTA) updates are being heavily relied upon for updating various vehicle electronics, including various vehicle modules and electronic control units. Security vulnerabilities are important as the authenticity and integrity of the electronic data embodying the software update should be verified before executing the update. Code signing of software images is a common security mechanism used for SOTA updates, particularly where a signature is appended to the message/electronic data in order to allow the recipient to verify the integrity and authenticity of the SOTA update.

The landscape of automotive software architecture is undergoing significant transformation, influenced by emerging trends in the industry such as advanced driver assistance systems (ADAS), autonomous vehicles, connectivity features, and shifts in car ownership and usage patterns. New architectural approaches like virtualization and the use of hypervisors, as well as the adoption of Adaptive AUTOSAR and Flexible Classic AUTOSAR platforms, are leading to a more modular design. This approach breaks down the electronic control unit's (ECU) monolithic software into multiple independent binaries that can be developed, tested, and updated separately. This shift is making car software more akin to mobile software, where various applications are delivered as separate packages and then assembled within the vehicle based on specific requirements.

The transition to modern automotive software architecture, where an ECU no longer uses a single binary image from one provider but rather a collection of images from multiple independent vendors, presents new challenges in the application of traditional code signing practices. This architectural shift necessitates alterations in software release processes. Conventional methods involve the individual signing of each software image with a unique key pair. To manage dependencies among these various software components, the ECU utilizes metadata, which includes version information of the software that is communicated during the preparation phase of a software update.

There is a need for a solution that reduces the number of keys and provides the appropriate security for the ECU while receiving images from different vendors, among other security improvements and efficiencies.

### SUMMARY

According to one aspect of the disclosure, there is provided a method of deploying software to a target device. The method includes: receiving a software image and a root signature generated based on the software image; determining a software image hash based on the software image; determining a client-side root of a hash tree based on the software image hash; decrypting the root signature to obtain a server-side root; determining whether the server-side root matches the client-side root; and configuring software on a target device using the software image when the server-side root matches the client-side root.

According to various embodiments, the method may further include any one of the following features or any technically-feasible combination of some or all of the features:
hash tree data representing the hash tree is stored at the target device prior to the method, and wherein the step of determining the client-side root of the hash tree includes using the hash tree as updated with the software image hash;
the server-side root is or is based on a root hash value of a server-side hash tree maintained by a server, and wherein the server-side hash tree corresponds to the hash tree stored at the target device;
the target device includes a master electronic control unit (ECU) and a target ECU, wherein the master ECU sends the software image and the root signature to the target ECU, and wherein the target ECU performs the method in order to configure the software on the target ECU;
the target ECU sends a confirmation message to the master ECU upon successful configuring of the software;
the target device is a vehicle, and the method is performed by the vehicle in order to update software or install new software on the vehicle;
the hash tree is for a plurality of software cluster images for a plurality of software clusters including a target software cluster that is to be updated using the software image, which is referred to as a target software image, and wherein the target software image is installed on a target electronic control unit (ECU);
the target ECU includes an ECU image comprised of at least one software cluster image taken from the plurality of software cluster images of the hash tree;
the ECU image of the target ECU includes the plurality of software cluster images so that the hash tree is for the target ECU as each software cluster of the plurality of software clusters corresponds to a software cluster image that is installed on the target ECU;
a software cluster image hash is determined for each software cluster of the plurality of software clusters using software for the software cluster, and wherein the hash tree is built based on the software cluster hash for each of the plurality of software clusters; and/or
further comprising the step of updating hash tree data representing the hash tree in response to determining that the server-side root matches the client-side root so that the hash tree reflects software configured for operation on the target ECU, including the software configured on the target device for the target software cluster.

According to other aspects of the disclosure, there is provided: a software provisioning system having at least one processor and non-transitory, computer-readable memory storing computer instructions that, when executed, cause the method to be performed; an electronic control unit (ECU) having a processor and memory configured to perform the method; a vehicle subsystem having said ECU; and a vehicle having said vehicle subsystem.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram illustrating a communications system having a software provisioning system, according to one embodiment;

FIG. 2 is a block diagram illustrating a connected vehicle (CV) environment having a communications system, including a connected vehicle software provisioning system that enables configuring software on each of a plurality of target vehicles, according to one embodiment;

FIG. 3 is a block diagram and flowchart illustrating an exemplary system configuration and workflow for updating software on a vehicle, according to embodiment;

FIG. 4 is a block diagram illustrating an exemplary hash tree or Merkle tree that is structured with a hash tree root along with a plurality of hash tree leaves, according to embodiment;

FIG. 5 is a block diagram and flowchart illustrating an exemplary hash tree over-the-air (OTA) scheme, according to embodiment;

FIG. 6 is a flowchart illustrating a method of deploying software to a target device, according to embodiment; and

FIG. 7 is a block diagram depicting a current or conventional software architecture for deploying code to a target device as well as “New Software Architecture”, which is implemented according to one or more embodiments of the present disclosure.

### DETAILED DESCRIPTION

A hash tree based over-the-air (OTA) software provisioning and verification system and method are provided, which enable portions of software (“software clusters”) to be deployed (e.g., as an update or new software) on an electronic control unit (ECU). In particular, the system and method use a Merkle tree or hash tree where each of its leaves corresponds to a software cluster and is represented by a software cluster hash generated based on hashing software of the software cluster. The hash tree includes a root (represented by a root hash) that is based on every hash of the tree, including each of the software cluster hashes. In embodiments, the hash tree is a binary hash tree where each non-leaf node is a hash generated based on two children hashes, and the binary hash tree may include a number of layers dependent on the number of leaves or software clusters; however, of course, any of a number of suitable hash trees may be used in which the root is necessarily dependent on each leaf hash; for example, a trinary or ternary hash tree may be used.

In embodiments, the system and method are implemented in an automotive context, where the ECU being updated (referred to as a target ECU) is carried by a vehicle as a part of vehicle electronics. According to at least some embodiments, the target ECU performs a method of updating software, which includes a logical implicit signature verification process, at least in some embodiments. The logical implicit signature verification process verifies received software to be installed on the target ECU through use of the hash tree; in particular, a received root signature is decrypted to obtain a server-side root that is compared to a client-side root calculated at the target ECU based on an updated hash tree incorporating a hash of the received software, which is referred to as a software image hash. The software image hash is for a software cluster (specifically, a target software cluster) and, accordingly, is also a software cluster hash. As a part of the logical implicit signature verification process, the hash tree (stored as hash tree data) is updated by hashing the received software to generate the software image hash for the target software cluster and replacing or inserting a software cluster hash for the software cluster with the software image hash (an updated software cluster hash).

It will be appreciated that, while the present embodiment is discussed in an automotive context, the system and method may also be applied to a wide variety of fields using connected devices that receive over-the-air (OTA) software, such as OTA software updates or OTA new software updates.

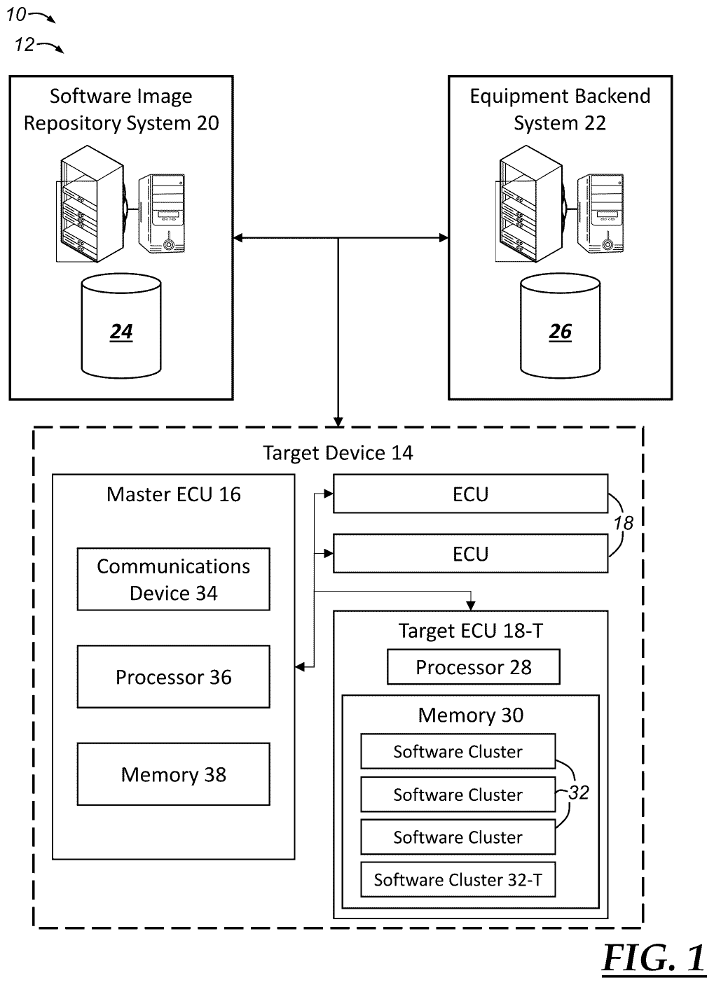

With reference now to FIG. 1, there is shown a communications system 10 that includes a software provisioning system 12 and a target device 14 that has a master electronic control unit (ECU) 16 and a plurality of other ECUs 18, one of which is depicted as presently being targeted for software provisioning and is referred to as a target ECU 18-T. The software provisioning system 12 includes a software image repository system 20 that stores software images that are used for the ECUs of the target device 14, and further includes an equipment backend system 22 that uses a private cryptographic key it holds to generate an encrypted signature based on a hash of the software image. The equipment backend system 22 is system managed by a manufacturer or servicer (“device servicer”) of the target device 14, such as an original equipment manufacturer (OEM) in an automotive context.

The software provisioning system 12 is used to provide software images to the target device 14 for purposes of installing the software on the target ECU 18-T. The software provisioning system 12 is located remotely from the target device 14 in the illustrated embodiment, with the target device 14 being a connected device that is in communication with the software provisioning system 12. The software image repository system 20 includes a software image repository 24, which is a repository where the software image (to be sent to the target ECU 18-T) is stored. In embodiments, the software image repository system 20 is managed by a software holder, which is a party that maintains the software image, and the software holder is separate from the device servicer that manages the equipment backend system 22. In embodiments, the software image repository system 20 generates a software image hash of a software image to be released, and then sends the generated software image hash to the equipment backend system 22.

The equipment backend system 22 includes an equipment repository 26 that stores private cryptographic keys (“private keys” for short), each of which is a part of a public-private cryptographic key pair (“key pair” for short). The equipment backend system 22 is also used to generate an encrypted signature using a private key for the target ECU, and then to send the encrypted signature back to the software image repository 24.

The target device 14 is the device that is configured using software from the software provisioning system 12 and, more particularly, includes the target ECU 18-T that is targeted for being configured using the software. The target device 14 includes or is the target ECU that is to be configured and the target ECU 18-T includes at least one processor (shown and exemplarily described herein as a processor) 28 and memory 30 provisioned or initially configured with a plurality of software, each referred to as a software cluster 32; a “software cluster image” is an image or other data representing software, such as an executable binary image, of a software cluster. A software cluster may be associated with many software cluster images, each of which may be for a different software release or version. A target software cluster 32-T is the software cluster targeted for configuration. The other two ECUs 18 are analogous to the target ECU 14, except that these two other ECUs 18 are not presently targeted for update in the illustrated embodiment of FIG. 1. These other ECUs 18 may include at least one processor and memory having a plurality of software clusters, like that of the target ECU 18-T. In embodiments, the target device 14 may have a single ECU.

It will be appreciated that, while the present embodiment addresses the case where the relevant software clusters are located in the same ECU target (ECU 18-T), the system and method may also be applied to other architectures or configurations where the software clusters may be distributed across different ECUs or systems. In this case, the ECU 18-T obtains (for example, through the master ECU 16 or the equipment backend system 22) the hashes of these software clusters or intermediate hashes, so it can calculate the tree root.

The target device 14 is also illustrated as including the master ECU 16; however, it should be appreciated that, in other embodiments, the master ECU 16 is omitted or is the target ECU. In such embodiments, the target ECU may communicate directly (without a separate ECU of the target device used for external communications) with the software provisioning system 12. However, in at least some embodiments, including the illustrated embodiment of FIG. 1, the target device 14 includes the master ECU 16, which is used for communicating with the software provisioning system 12. The master ECU 16 includes a communications device 34, such as a cellular chipset or dedicated short-range wireless communications (e.g., Wi-Fi™, Bluetooth™), and further includes a processor 36 and memory 38. The master ECU and the target ECU 18-T (and the other two ECUs 18) are communicatively coupled, as shown in FIG. 1, to each other, such as through a communications bus or a local network connection via dedicated short-range wireless communications, for example.

According to embodiments, the target device 14 includes a variety of other electronic or electrical components, as those skilled in the art will appreciate that the system(s) and method(s) discussed herein are applicable to a number of different environments, generally; however, at least according to embodiments, the system(s) and method(s) have been adapted to a connected vehicle (CV) setting in which a plurality of vehicles are each configured to receive software from the software provisioning system 12, which may be implemented via a backend server system, and each to configure a target ECU within the vehicle using the software. Particulars of such a vehicle-based over-the-air (OTA) software provisioning system and method are discussed below, according to embodiments.

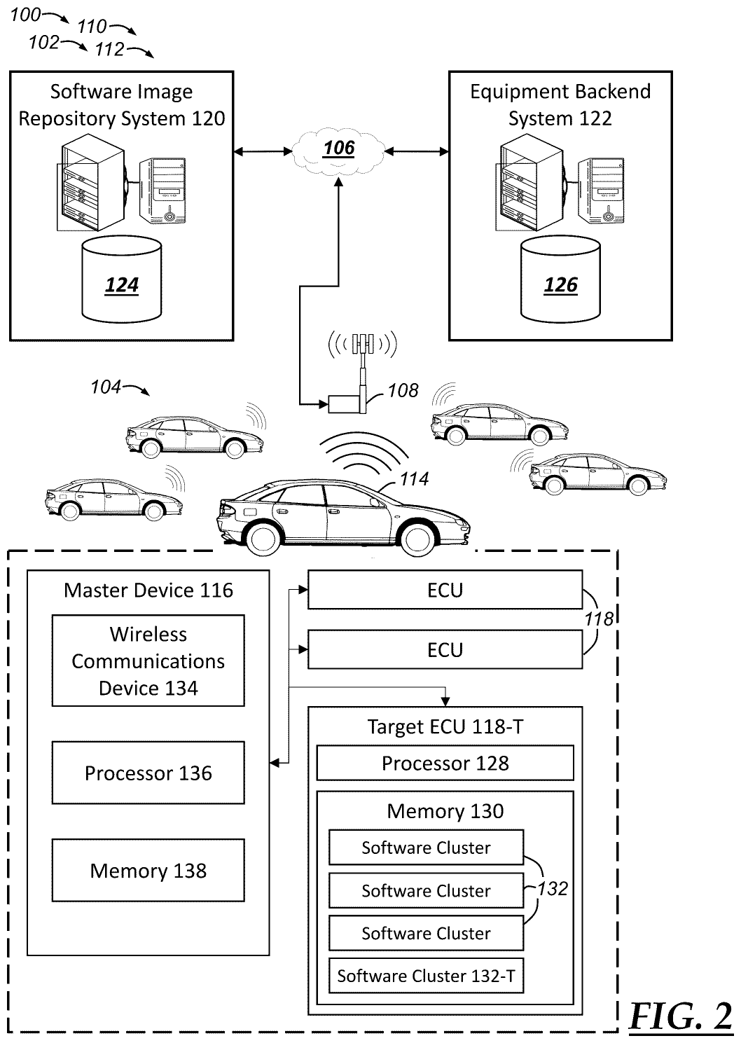

With reference to FIG. 2, there is shown a connected vehicle (CV) environment 100 having a communications system 110, including a connected vehicle software provisioning system 102 that enables configuring software on each of a plurality of target vehicles 104, one of which is shown and described below as target vehicle or target device (or simply “vehicle”) 114. Each of the other vehicles 104 may also be configured in a like manner as target vehicle 114, and a variety of different vehicles may be used as the plurality of vehicles 104. According to embodiments, the vehicles 104 need not necessarily be of the same make and model.

Like reference numerals amongst FIGS. 1 and 2, particularly those defined by X=Y mod 100 where X is a FIG. 1 numeral and Y is a like FIG. 2 numeral, indicate that such devices or components are analogous to one another with respect to the teachings herein. The discussion above in connection with components X of FIG. 1 is hereby attributed to those like components Y in FIG. 2—that is, for example, the discussion of the software provisioning system 12 (X=12) of FIG. 1 is hereby attributed to the software provisioning system 112 (Y=112) of FIG. 2.

The communications system 110 includes an interconnected data network 106 that is shown as being coupled to a wireless carrier system 108, which may be a cellular carrier system, for example. The plurality of vehicles 104 communicate with the software provisioning system 112 via the interconnected data network 106, which may include data communications carried out over the internet. The software provisioning system 112 includes a software image repository system 120 having a software image repository 124 and an equipment backend system 122 having an equipment repository 126.

The vehicle 114 includes a master device 116 and a plurality of electronic control units (ECUs) 118, including a target ECU 118-T. The master device 116 includes a processor 136, memory 138, and a wireless communications device 134 used for communications with the software provisioning system 112. The target ECU 118-T, which may be a body control module (BCM), for example, includes a processor 128 and memory 130 used for storing a plurality of software clusters 132, including a target software cluster 132-T.

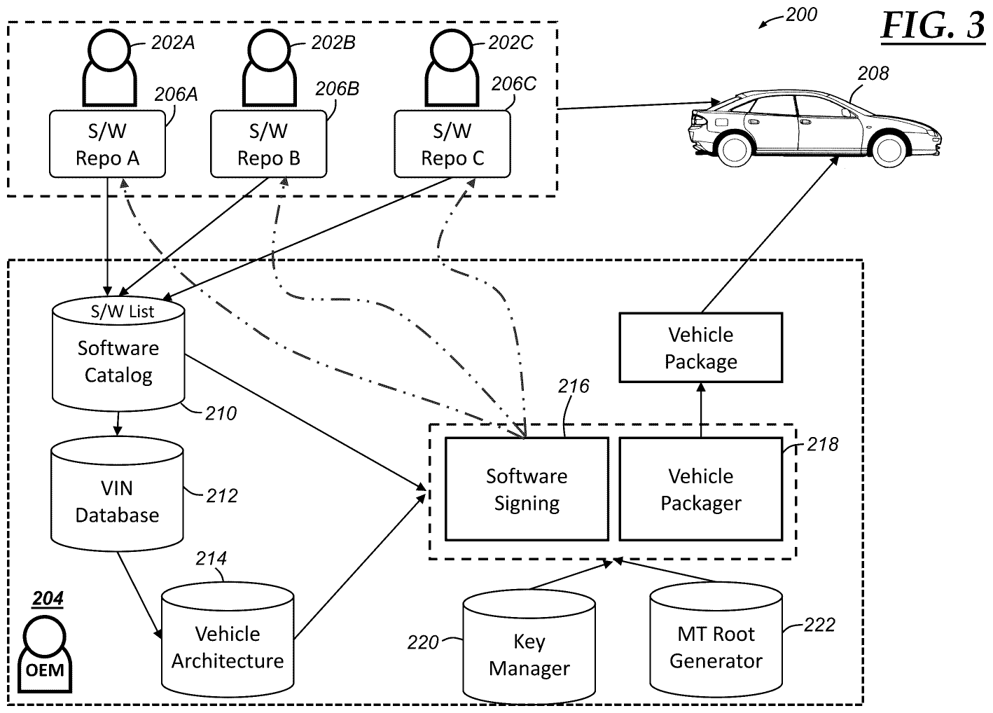

With reference to FIG. 3, there is shown an exemplary system configuration and workflow 200 for updating software on a vehicle. The example shown in FIG. 3 includes three software providers 202A-C and an original equipment manufacturer (OEM) backend system 204 that is an equipment provider. The software providers each include a software image repository 206A-C, each of which may correspond to the software image repository 124 (FIG. 2), and each of which may be used for updating a different software cluster of a target vehicle 208.

The OEM backend system 204 includes a software catalog 210, a vehicle identification number (VIN) data store 212, a vehicle architecture data store 214, a software image signer 216, a vehicle software information packager 218, a key manager 220, and a hash or Merkle trec (MT) root generator 222. The OEM backend system 204 generates an encrypted signature or root signature based on a software image hash, such as a target software image hash, which is a software image hash that is a target for being deployed or distributed. The software catalog 210 stores a list of the software clusters used in the ECU(s) of the target device(s), such as through listing a software cluster identifier (ID) for each software cluster as well as a software cluster version ID for each deployed or distributed software cluster, each of which may correspond to a different software version or release. The software catalog 210 may also include other data concerning the software clusters, such as sizes of and other metadata relating to software cluster images, for example. The VIN data store 212 stores VINs of a plurality of vehicles, each of which may be considered the target device or vehicle 208; in other embodiments, other vehicle identifiers may be used instead of a VIN. The VIN data store 212 may more generally be referred to as a target vehicle data store, and may further include information identifying a software archetype of the vehicle. The vehicle architecture data store 214 includes information concerning the software archetype of the vehicle; as used herein, “software archetype” refers to a model or representative architecture, configuration, or arrangement of software that is defined for a set of target devices (e.g., vehicles), and software archetypes may range in the number, type, arrangement, and configuration of ECUs, including software capabilities information, permissions information, etc.

The software image signer 216 is used to generate a signature (or root signature) using a hash tree root as generated by the hash tree root generator 222. The vehicle software information packager 218 is used to package software manifest data for the target vehicle, and this package is sometimes referred to as a “vehicle package”, but more generally may be referred to as a software metadata package. The key manager 220 is used to manage cryptographic keys and, more particularly, a set of ECU key pairs where each ECU key pair is a public-private key pair that is specified for an ECU; in embodiments, there is a one-to-one relationship between ECUs and the ECU key pairs such that each ECU of the target device 208 has a single key pair for use in verifying software to be installed at the ECU. However, in other embodiments, the ECUs may be virtualized so as to implement the method using different relationships among the number of ECUs and corresponding ECU key pairs. The hash root generator 222 is used to generate the root hash or (hash tree root or Merkle root or hash root) of the hash trec. The hash tree root from the hash root generator 222 and a private cryptographic key from the key manager 220 are used by the software image signer 216 to digitally sign the hash tree root thereby generating an encrypted signature or encrypted root signature.

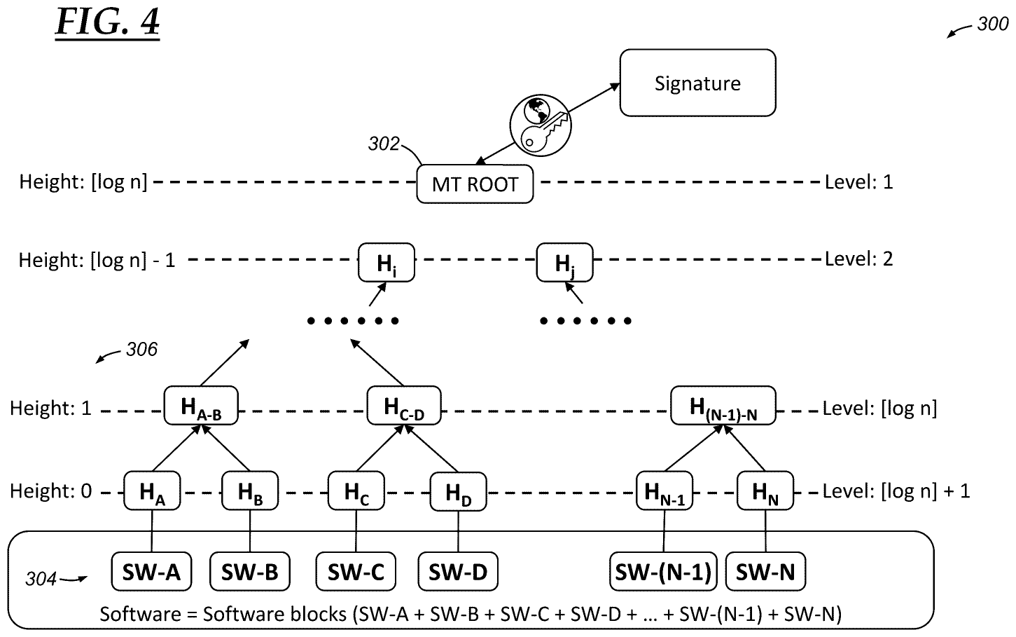

With reference to FIG. 4, there is shown an exemplary hash tree or Merkle tree 300 that is structured with a hash tree root 302 along with a plurality of hash tree leaves 304, each of which corresponds to a single software cluster, at least according to the depicted embodiment. The hash tree 300 further includes intermediate level(s) 306, each of which is considered to be at a different height, as shown in FIG. 4; moreover, the height of the hash tree 300 is (log₂n) where n is the number of hash tree leaves 304 (or N in FIG. 3) and where the level or height at which the hash tree leaves 304 are located is considered to have a height of zero (0). The logarithm functions shown in FIG. 4 are base two (2) logarithms—i.e., log₂.

Located at each node within the intermediate level(s) 306 is an intermediate hash, which is a hash that is generated based on all of the children of the node. The exemplary hash tree 300 is a binary hash tree in that each non-leaf node has two and only two children; however, according to embodiments, other hash trees, such as those having three or more leaves, may be used. In one embodiment, each non-leaf node hash is determined by concatenating a first (or left) child hash and a second (or right) child hash, such as: hash of (left child hash∥right child hash). According to one embodiment, creating the hash tree includes: (1) taking a first set of hash results Hi of the software image SWi, which each represents a child node in the hash tree; (2) these child nodes are combined (e.g., in pairs) to provide the first combined hash nodes, and the value of the parent node is generated based on a hash of the children nodes, such as based on a concatenation of the two children nodes (hash (left∥right)), for example, where concatenation is represented by ∥; and (3) these hash results are further combined (e.g., in pairs) to an intermediate level hash results, and these intermediate level hash results are repeatedly paired and combined until only a single combined hash result remains, which is the Merkle tree Root or hash tree root. In addition to the tree information, there are additional management information that may be saved. Each software cluster has a unique ID that will be used to locate the cluster in the Merkle tree. An exemplary setup phase is described below in Algorithm 1, and a similar setup is done in the backend server as well as in the ECU, in embodiments. It should further be appreciated that other hash trees may be used instead of a binary hash tree, such as a ternary hash tree in which three sibling hashes are concatenated (left∥middle∥right) in order to generate a hash for a parent node.

The following hash tree creation algorithm (“Algorithm 1”) may be used to create the hash trec (the two-dimensional “tree” array Algorithm 1) in order to generate or create the hash trec root (e.g., “tree[HT][0]” in Algorithm 1) based on an inputted list of software cluster identifiers (“Software ID (SWi)”), software cluster addresses (“Addresses”) indicating where the software is stored, and sizes of the software (“Sizes(Si)”). This algorithm addresses a static tree design where software nodes are assigned sequentially to the leaf nodes at the bottom level. It is possible to build the tree in a different way, for example, dynamically, such that the tree accommodates only for available software clusters, and follow a top-bottom approach to keep the height of the tree as small as possible.

Algorithm 1: Hash Tree Creation

```
INPUT: list of Software ID(SWi), Addresses(location),
and Size(Si)
OUTPUT: Merkle Tree Root
FUNCTION: BuildMerkleTree
    for i=1 to Nmax
        if (SWi exists)
          Calculate Hi and save as child node in tree
          Increase number of available SW
    end
    Calculate Merkle tree contents (MT[i][j]):
    for i= 1 to HT
      for j=0 to (2^{HT-i} − 1)
          MT[i][j] = hash (MT[i−1][2j], MT[i−1][2]+1])
      end
    end
end.
where:
  SW = Sw1, . . . , SwN: SW is the software image which is
    represented as a set of software images of different size
  N is the total number of SW clusters in the ECU image
  Nmax is the max number of SW clusters that can reside in the
    ECU throughout the lifetime of the ECU
  Si = ||SWi|| is the size of a software cluster in bytes
  Hi is the Hash value of the SWi cluster code
  ||Hi|| is the size of Hi
  HT: is the Merkle Tree height. The height at the root node is
    considered HT
  SW-M is the modified SW cluster, SW-M ∈ SW
```

As discussed above, the tree creation algorithm is used to generate a hash tree data object, which is represented as a two-dimensional array in Algorithm 1, with i being the index of the layer and j being the index of the node with layer i (“tree[i][j]”). The hash tree data object is stored in a data store that is secured and that may be hosted by the equipment servicer.

According to embodiments, the hash tree is generated as a part of a setup phase, which may include creating a full binary hash tree using the hashes of all existing software clusters. In embodiments, it may be desirable to have the hash tree accommodate Nmax nodes that might be deployed throughout the ECU lifecycle. The binary Merkle tree is a tree constructed bottom-up, with height equal to HT, and can have up to 2^{HT} child nodes.

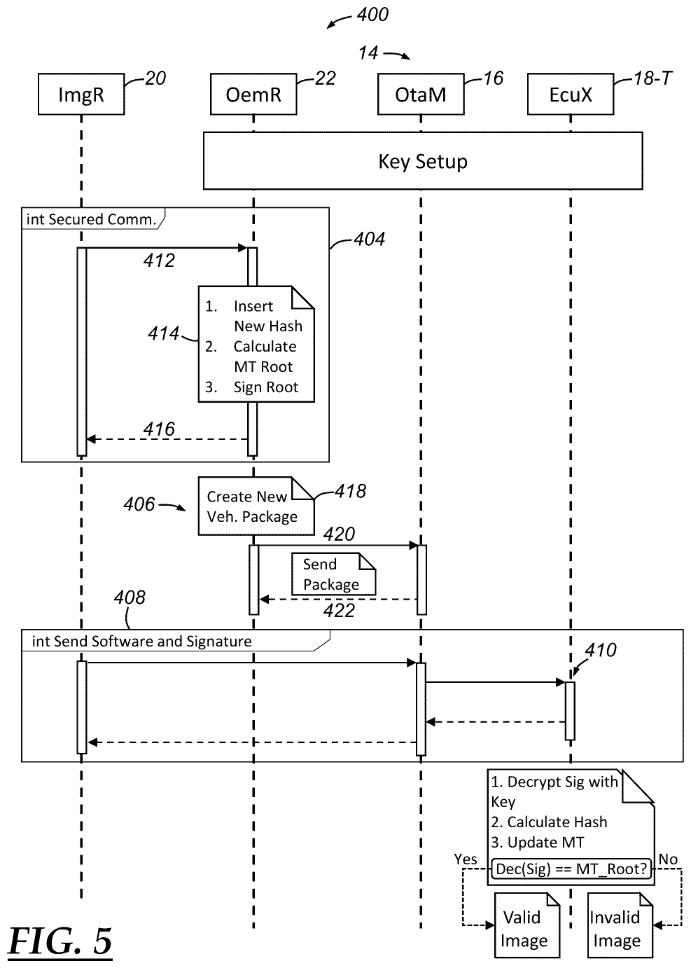

With reference to FIG. 5, there is shown a hash tree over-the-air (OTA) scheme 400, according to one embodiment. The hash tree OTA scheme 400 begins with a cryptographic provisioning process or key setup process 402 in which cryptographic keys or secrets are distributed to the appropriate parties, which are the target ECU 18-T and the equipment backend system 22, as shown in the exemplary embodiment of FIG. 5. The rest of the OTA scheme 400 then shows processes used for deploying a software image for a software cluster to the target ECU 18-T, including a root signature generation process 404, a software cluster image metadata dissemination process 406, and a software signing and deployment process 408 having a software image verification process 410 that is used to verify the received data purporting to be the software image (a purported root referred to as a server-side root) to be installed onto the target device.

The key setup process 402 is used to distribute cryptographic keys and, in one embodiment, includes distributing a public ECU key to the target ECU 18-T and storing a private ECU key at the key manager 220. In other embodiments, a private symmetric key encryption scheme may be used, for example.

The root signature generation process 404 is used to generate a root signature, which is the root encrypted with a private or secret key. In particular, the root signature generation process 404 includes determining a software image hash of the software image (that is to be deployed), sending the software image hash (or “New Hash Value” in FIG. 5) from the software image repository system 20 to the equipment backend system 22 as shown at 412, generate the root signature as shown at 414, and sending the root signature back to the software image repository system 20, as shown at 416. At operation 414 of generating the root signature, there is shown a set of three steps, comprising: (1) insert the software image hash (“new hash”) into the corresponding hash tree; (2) calculate the new hash tree (“Merkle Tree”) root, and sign the new hash tree root with the secret associated with the ECU, which may be the ECU private key.

The software cluster image metadata dissemination process 406 is used to distribute information about the software images or software clusters to the target device, such as to the master ECU 16, as shown in FIG. 5, and this information is referred to a software metadata package. The software metadata package is created by the equipment backend system 22, as shown at 418, and is then sent to the master ECU 16 (as shown at 420), which may then acknowledge receipt, as shown at 422.

The software signing and deployment process 408 includes sending the encrypted signature along with the software image from the software image repository system 20 to the target device 14 and, more particularly, the target ECU 18-T via the master ECU 16. The target ECU 18-T then performs the software image verification process 410 in order to verify the integrity of the contents received purporting to be the software image. Details of this process 410 are discussed more below.

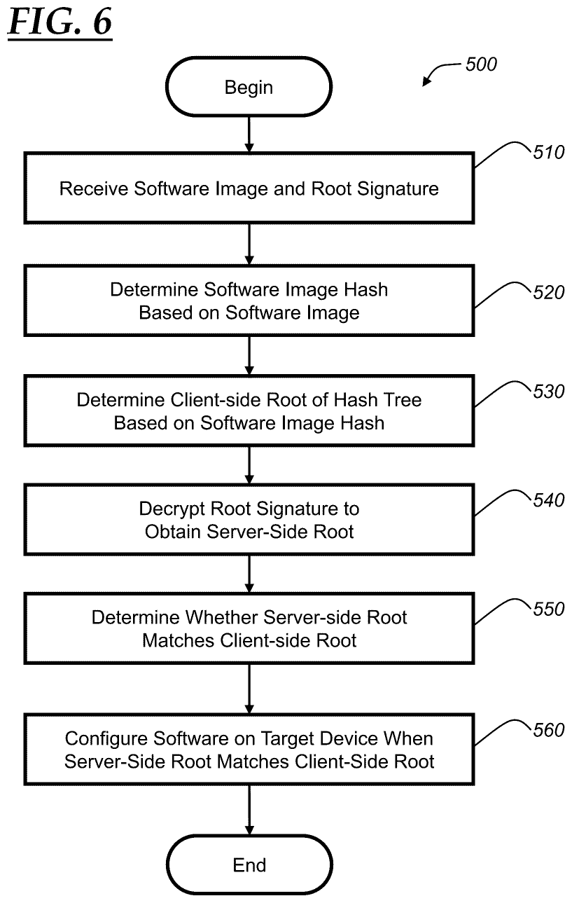

With reference to FIG. 6, there is shown a method 500 of deploying software to a target device. The method 500 is performed by the target device 14 and, in embodiments, by the master ECU 16 and/or the target ECU 18-T; more particularly, in one embodiment, the method 500 is performed by the target ECU 18-T and, in other embodiments, the master ECU 16 may perform one or more steps of the method 500 in combination with the target ECU 18-T. The method 500 is described as having steps 510-560 being performed in a particular order; however, it will be appreciated that the steps 510-560 may be performed in any technically-feasible order.

The method 500 begins with step 510, wherein a software image and a root signature determined based on the software image are received. The software image is data representing software to be installed onto the target ECU and may be in the form of an executable binary image, for example; however, it will be appreciated that the software image may be in any suitable electronic format. According to embodiments, the software image and the encrypted signature are provided by the software provider from the software image repository system 20; however, in other embodiments, the equipment backend system 22 may provide the software image and/or the root signature. The method 500 continues to step 520.

In step 520, a software image hash is determined based on the software image. The software image hash is determined by computing a hash of the software image that was received in step 510. The hash function used may be a SHA-2 digest, a SHA-3 digest, a BLAKE digest, RIPEMD-160 digest, or a SM3 digest. The storage size of the hash tree depends on the size of the hash output itself. The main security profiles of computation of hashes:
SHA-2: Length: 224, 256, 384, 512
SHA-3: Length: 224, 256, 384, 512
BLAKE: Length: 224, 256, 384, 512
BLAKE: Length: 224, 256, 384, 512
RIPEMD-160: Length: 128, 160, 256, 320
SM3: Length: 256
   The Merkle tree height increases exponentially with the number of nodes. Also, the higher the tree, the more storage the ECU needs. Assuming SHA-2-256 is used as the hash algorithm, each node requires 32 bytes for the hash value. The following table shows how many bytes are taken to store complete Merkle tree based on number of software cluster nodes.

TABLE 1

| Height | Max number of nodes | Tree storage in bytes |
|---|---|---|
| 1 | 2 | 96 |
| 2 | 4 | 224 |
| 3 | 8 | 480 |
| 4 | 16 | 992 |
| 5 | 32 | 2016 |
| 6 | 64 | 4064 |
| 7 | 128 | 8160 |

The method 500 continues to step 530.

In step 530, a client-side root of a hash tree based on the software image hash is determined. The hash tree is represented by hash tree data that is stored at the vehicle prior to the method, such as a result of the provisioning discussed above in connection with 402 (FIG. 5). The hash tree is updated using the software image hash that was determined in step 520, along with a software cluster identifier (ID) that identifies which leaf node in the hash tree corresponds to the software image. According to embodiments, the software being provisioned onto the target ECU 18-T is a new software cluster or an updated software cluster. Provided below are exemplary hash tree modification algorithms that may be used, namely Algorithm 2a for tree node modification and Algorithm 2b for tree node addition. Furthermore, Algorithm 2c may be used for hash tree removal in which a hash tree leaf node (corresponding to a software cluster) is removed from the hash tree.

```
Algorithm 2a: Tree Node Modification
INPUT: SW-M, Addresses(location), and Size(Si)
OUTPUT: Merkle Tree Root
FUNCTION: ModifyMerkleTree
  if (SW-M exist in MT)
    Calculate Hi and update it in MT
  for 0 to HT
    update path from updated node to top Root
Algorithm 2b: Tree Node Addition
INPUT: SW-M, Addresses(location), and Size(Si)
OUTPUT: Merkle Tree Root
FUNCTION: AddtoMerkleTree
  Calculate Hi and add new node to MT
  for 0 to HT
    update path from updated node to top Root
Algorithm 2c: Tree node Removal
INPUT: SW-M
OUTPUT: Merkle Tree Root
FUNCTION: RemovefromMerkleTree
  Invalidate node in MT
    for 0 to HT
    update path from updated node to top Root
```

After the hash tree is updated, the hash root of the updated hash tree is determined and is referred to as the client-side root as the root is determined at a client. The method 500 continues to step 540.

In step 540, the root signature is decrypted to obtain a server-side root. The server-side root is the hash root of the hash tree that is generated, stored, and kept at the backend, such as at the equipment backend system 22. The root signature is decrypted using a cryptographic key that is paired with the encryption key; in embodiments, the decryption key is a public ECU key that is provisioned for the ECU as a part of the key setup process 402. The method 500 continues to step 550.

In step 550, a determination is made as to whether the server-side root matches the client-side root. It will be appreciated that, after the hash for the root node is calculated (based on the updated hash tree), this hash (the root hash) may be further modified (re-hashed, for example); however, such a derivative value is still considered to be the root as it is derivable therefrom. Thus, there shall be no limitation that any discussed “root” (e.g., the server-side root, the client-side root) only refers to the first or initial root hash value; in this sense, a root is or is at least based on the initial root hash value but is not necessarily the first or initial root hash value. Nonetheless, the determination as to whether the server-side root matches the client-side root may be made by evaluating whether the server-side root is the same as the client-side root. When the server-side root matches the client-side root, the software image is considered a valid image or valid data; otherwise, the software image is considered an invalid image or data and the software image may be discarded and a response sent back to the software image repository system 20 and/or the equipment backend system 22. In such instances, the method 500 may proceed back to step 510 so that at least one more iteration of the steps 510-550 is performed (until the server-side root matches the client-side root). The method 500 continues to step 560.

In step 560, software on the target device is configured using the software image when the server-side root matches the client-side root. The software image for the software cluster is the software on the target device being configured, and this configuring includes installing the software represented by the software image onto the target ECU 18-T or otherwise configuring the target ECU 18-T so that it operates according to the software image. In embodiments, this includes storing the software image at the target ECU 18-T (in memory of the target ECU 18-T) and performing any other operations so that the target ECU 18-T is configured to execute the software instructions represented by the software image. The method 500 ends.

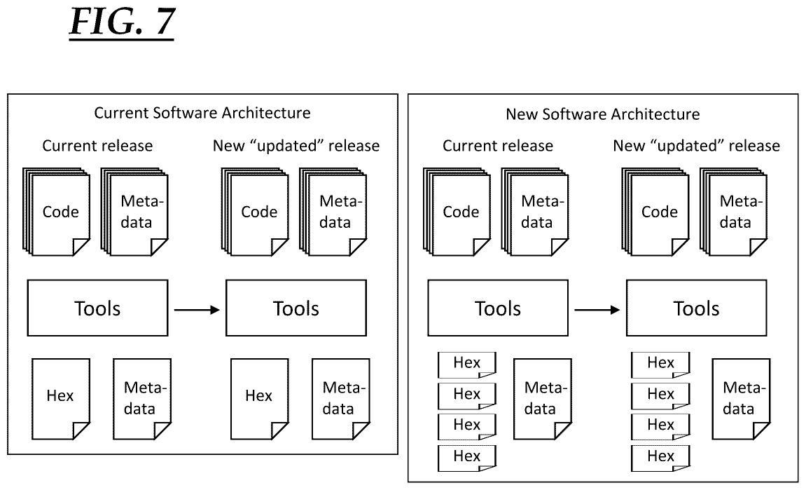

FIG. 7 depicts a current or conventional software architecture for deploying code to a target device as well as “New Software Architecture”, which is implemented according to one or more embodiments of the present disclosure. The current software OTA solutions are based on signing each software image individually with a dedicated key pair per image or at least per software cluster. Dependency checks between these software entities is done by the ECU using metadata shared with the ECU based on the version of the used software reported during the preparation of the software update.

The new software architecture, as discussed above, enables reducing the number of keys used the security for the ECU OTA software deployment while receiving images from different software vendors or providers. The proposed approach, working at the ECU level, complement the existing software OTA (SOTA) solutions by implementing a new hash tree-based or Merkle Tree-based algorithm to additionally address dependencies and conflicts among the software entities within the ECU using a logical implicit signature verification without adding much overhead to the process and while keeping key management in the vehicle compliant with the current process aiming one key set for SOTA services regardless of how many software images and vendors exist within the ECU, at least according to embodiments.

Any one or more of the processors or electronic processors discussed herein may be implemented as any suitable electronic hardware that is capable of processing computer instructions and may be selected based on the application in which it is to be used. Examples of types of electronic processors that may be used include central processing units (CPUs), graphics processing units (GPUs), field-programmable gate arrays (FPGAs), application specific integrated circuits (ASICs), microprocessors, microcontrollers, etc. Any one or more of the memory discussed herein may be implemented as any suitable type of non-transitory memory that is capable of storing data or information in a non-volatile manner and in an electronic form so that the stored data or information is consumable by the electronic processor. The memory may be any a variety of different electronic memory types and may be selected based on the application in which it is to be used. Examples of types of memory that may be used include including magnetic or optical disc drives, ROM (read-only memory), solid-state drives (SSDs) (including other solid-state storage such as solid-state hybrid drives (SSHDs)), other types of flash memory, hard disk drives (HDDs), non-volatile random access memory (NVRAM), etc. It should be appreciated that the computers or computing devices may include other memory, such as volatile RAM that is used by the electronic processor, and/or may include multiple electronic processors.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of deploying software to a target device, comprising:
receiving a software image and a root signature generated based on the software image;
determining a software image hash based on the software image;
determining a client-side root of a hash tree based on the software image hash;
decrypting the root signature to obtain a server-side root;
determining whether the server-side root matches the client-side root; and
configuring software on a target device using the software image when the server-side root matches the client-side root.

2. The method of claim 1, wherein hash tree data representing the hash tree is stored at the target device prior to the method, and wherein the step of determining the client-side root of the hash tree includes using the hash tree as updated with the software image hash.

3. The method of claim 2, wherein the server-side root is or is based on a root hash value of a server-side hash tree maintained by a server, and wherein the server-side hash tree corresponds to the hash tree stored at the target device.

4. The method of claim 1, wherein the target device includes a master electronic control unit (ECU) and a target ECU, wherein the master ECU sends the software image and the root signature to the target ECU, and wherein the target ECU performs the method in order to configure the software on the target ECU.

5. The method of claim 4, wherein the target ECU sends a confirmation message to the master ECU upon successful configuring of the software.

6. The method of claim 1, wherein the target device is a vehicle, and the method is performed by the vehicle in order to update software or install new software on the vehicle.

7. The method of claim 1, wherein the hash tree is for a plurality of software cluster images for a plurality of software clusters including a target software cluster that is to be updated using the software image, which is referred to as a target software image, and wherein the target software image is installed on a target electronic control unit (ECU).

8. The method of claim 7, wherein the target ECU includes an ECU image comprised of at least one software cluster image taken from the plurality of software cluster images of the hash tree.

9. The method of claim 8, wherein the ECU image of the target ECU includes the plurality of software cluster images so that the hash tree is for the target ECU as each software cluster of the plurality of software clusters corresponds to a software cluster image that is installed on the target ECU.

10. The method of claim 8, wherein a software cluster image hash is determined for each software cluster of the plurality of software clusters using software for the software cluster, and wherein the hash tree is built based on the software cluster hash for each of the plurality of software clusters.

11. The method of claim 10, further comprising the step of updating hash tree data representing the hash tree in response to determining that the server-side root matches the client-side root so that the hash tree reflects software configured for operation on the target ECU, including the software configured on the target device for the target software cluster.

12. A system configured to perform the method of claim 1.

13. An electronic control unit (ECU) having a processor and memory configured to perform the method of claim 1.

14. A vehicle subsystem having the ECU of claim 13.

15. A vehicle having the vehicle subsystem of claim 14.
